(19) United States
(12) Patent Application Publication
(10) Pub. No.: US 2018/0181089 A1
(43) Pub. Date: Jun. 28, 2018

(54) CONTROL DEVICE AND CONTROL METHOD

(71) Applicant: HITACHI, LTD., Tokyo (JP)

(72) Inventors: Taiki FUJI, Tokyo (JP); Kiyoto ITO, Tokyo (JP); Kanako ESAKI, Tokyo (JP)

(73) Assignee: HITACHI, LTD., Tokyo (JP)

(21) Appl. No.: 15/854,395

(22) Filed: Dec. 26, 2017

(30) Foreign Application Priority Data
Dec. 27, 2016 (JP) 2016-252822

(51) Int. Cl. G05B 13/04; G05B 13/02

(52) U.S. Cl. CPC G05B 13/042; G05B 13/0265

(57) ABSTRACT

A control device that determines an output value of an actuator based on an input value of a sensor, includes a control unit that includes a control model capable of changing a parameter; a control unit that includes a control model fixed in a parameter acquired by a different device; and an action selection unit that selects an output value from output values of the respective control units and outputs the selected output value to an actuator, and determines an output value of the actuator, based on an input value from a sensor of a machine.

### BACKGROUND OF THE INVENTION

### Field of the Invention

The present invention relates to a control device and a control method that determine an output value of an actuator, based on an input value from a sensor, in a machine which achieves a task given in a predetermined environment.

### Background Art

Recently, a structure of a mechanical device has been complicated and a work range has been expanded, and thereby, the number of inputs and outputs increases, and adjustment of machine control by trial and error in the field is performed. Here, the machine is defined as having a sensor, an actuator, and a control device as elements, and the machine control is defined as executing a given task by processing an input value from a sensor by a control device and determining an output of the actuator. In order to realize the machine control, it is necessary to determine parameters of a control model (a function for determining an output according to an input) that determines an operation of the control device.

A method for using reinforcement learning has been proposed as a parameter adjustment automation method of related art (H. Kimura, K. Miyazaki, and S. Kobayashi, “reinforcement learning in POMDPs with function approximation.” in Proc. of ICML '97, pp. 152-160, 1997.). In the reinforcement learning, a control model for adapting to environment (control target) through trial and error is acquired by learning. Unlike so-called supervised learning, instead of explicitly obtaining a correct output (action) for a state input of the environment, reward learns a scalar value with a clue.

In reinforcement learning of a machine control, a subject of the learning is a control device which includes a control unit and a learning unit. The control unit determines a control value of an actuator in accordance with state observation of an environment (control target) obtained from a sensor. In addition, as the actuator operates in the environment, the environment changes, and the learning unit receives a reward according to an achievement degree of a given task. The learning unit updates parameters of a control model such that an action maximizing a gain (high action value) is taken by evaluating an expectation value of the total reward to which a certain discount rate is applied, and acquires a control model for achieving the given task.

If a mechanical device has an unknown parameter with uncertainty or difficulty in measurement, it is not obvious to a designer how to achieve a task or how to reach a goal, and it is hard work for the designer to program a control rule to perform the task for a control device. However, in a case where reinforcement learning is used, as the designer instructs “what should be done” to the control device in a form of reward, there is an advantage that the control device itself can automatically acquires “how to realize” by learning.

However, since trial-and-error learning takes much time, a parallel learning method aiming at efficient learning is invented (JP-A-2005-078516). According to the invention, a plurality of learning means (algorithms) are operated in parallel and results of a selected strategy are shared and learned by other learning means, and thus, efficient learning is made, compared with a case where learning is made from the beginning by one piece of learning means.

### SUMMARY OF THE INVENTION

A method of related art is a mechanism assuming learning from the beginning, and the invention disclosed in JP-A-2005-078516 merely improves efficiency in using one piece of learning means, and there is a problem that adjustment cost which is the same as the past cost is required for each time a new machine is introduced. In order to aim for further efficiency improvement, a method of efficiently learning a new control model by reusing an existing control model is required.

An object of the present invention is to provide a control device and a control method which efficiently learn a new control model, based on an existing control model, and control a target, without updating the existing control model by using a parallel control learning device in which only a control model of a control unit of a learning target is connected to a learning unit.

In order to solve the above-described problem, a control device according to the present invention is configured to include a state acquisition unit that acquires a state value of a control target from a sensor value, a first control unit that includes a first control model and outputs an action of the control target and an action value, based on the state value and the first control model; a second control unit that is connected in parallel to the first control unit, includes a second control model, and outputs an action of the control target and an action value, based on the state value and the second control model; an action value selection unit that selects action values which are output from the first control unit and the second control unit; and a learning unit that receives an action value and an action which are selected by the action value selection unit, stores the action value and the action together with the state value, and updates a parameter of the first control model which is included in the first control unit, based on the stored data.

In addition, as another aspect of the present invention, the control device may include in parallel a plurality of the first control units having respectively different control models which are included therein.

In addition, as still another aspect of the present invention, the control device may further include an updating model selection unit that is connected to the plurality of first control units and selects to update parameters of a control model which is included in the first control unit.

In addition, in order to solve the above-described problem, a control method according to the present invention is configured to include a step of acquiring a state value of a control target from a sensor value; a step of causing a first control unit to output an action of the control target and an action value, based on the state value and the first control model which is included therein; a step of causing a second control unit to operate in parallel with the first control unit, and to output an action of the control target and an action value, based on the state value and a second control model which is included therein; a step of causing an action value selection unit to select action values which are output from the first control unit and the second control unit, to output the selected action value and action to the learning unit, to output the selected action to an actuator of the control target, and to control an operation of the control target; and a step of causing a learning unit to receive an action value and an action which are selected by the action value selection unit, stores the action value and the action together with the state value, and updates a parameter of the first control model which is included in the first control unit, based on the stored data.

According to the present invention, it is possible to speed up learning by efficient search based on an existing control model. In addition, it is possible to learn a control target in a case where inputs and outputs of the existing control model and a learning destination are different from each other.

### BRIEF DESCRIPTION OF THE DRAWINGS

FIG. 1 is a block diagram illustrating a configuration of a control device according to Embodiment 1 of the present invention.

FIG. 2 is a flowchart illustrating a basic operation of the control device according to Embodiment 1.

FIG. 3 is a maze of a shortest path search problem used in Embodiment 2.

FIG. 4 is a diagram illustrating an efficient learning method in an optimum path search of a carriage travel robot according to Embodiment 2.

FIG. 5 is a block diagram illustrating a configuration of a control device according to Embodiment 2.

FIG. 6 is a comparison graph of the number of searches representing performance of a control method of the present invention according to Embodiment 2.

FIG. 7 is a view illustrating combined learning of a robot and an existing control model used in Embodiment 3.

FIGS. 8A to 8C are views illustrating data used for a state value to be input to each control model used in Embodiment 3.

FIG. 9 is a block diagram illustrating a configuration of a control device according to Embodiment 3.

FIG. 10 is a view illustrating decomposition learning of a robot and an existing control model used in Embodiment 4.

FIG. 11 is a block diagram illustrating a configuration of a control device according to Embodiment 4.

FIG. 12 is a block diagram illustrating a configuration of an efficient learning method of a plurality of control models used in Embodiment 5.

### DETAILED DESCRIPTION OF THE INVENTION

Hereinafter, embodiments of the present invention will be described with reference to the drawings in detail.

### Embodiment 1

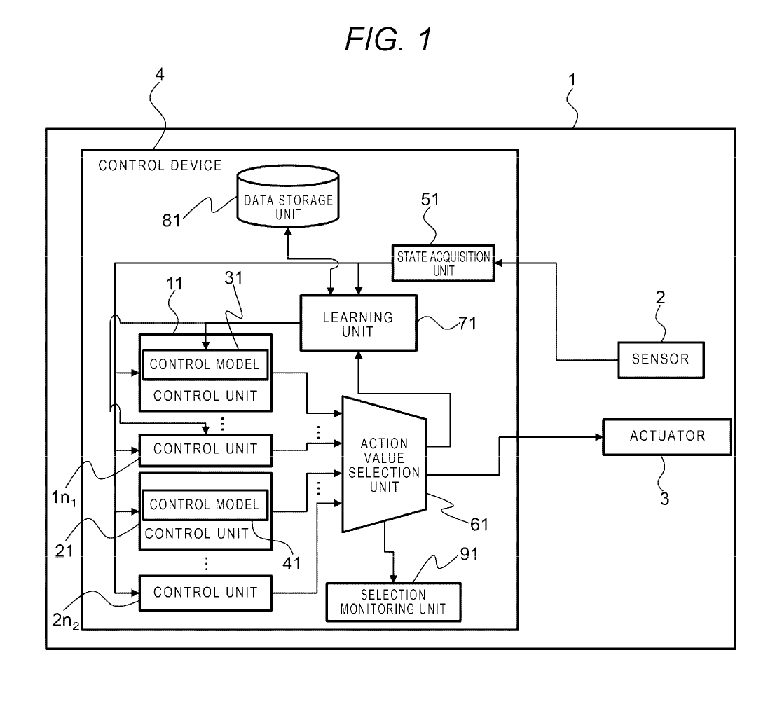

FIG. 1 is a block diagram illustrating a configuration of a control device according to Embodiment 1 of the present invention. In a machine 1 (main body of a mechanical device is not illustrated) illustrated in FIG. 1 or the like, the control device 4 according to the present embodiment includes a state acquisition unit 51 that processes input values from at least one sensor 2 or the like mounted inside the machine and determines state values that are output to control units 11 to 1n₂ and 21 to 2n₂ and a learning unit 71, one or more control units 11 to 1n₂ including control models 31 to 3n₁ that update parameters, one or more control units 21 to 2n₂ including control models 41 to 4n₂ which do not update the parameters and operate in parallel with each other separately from the control units 11 to 1n1 that update the parameters, an action value selection unit 61 that selects an action, based on action values output by each of the control units 11 to 1n₂ and 21 to 2n₂, a learning unit 71 that updates parameters of the control models 31 to 3n₁ of the control units 11 to 1n₁, a data storage unit 81 that transmits and receives data to and from the learning unit 71, and a selection monitoring unit 91 that is connected to the action value selection unit 61 and monitors and records an action value and an action selected by the action value selection unit 61 and the number of selections of each of the selected control units 11 to 1n₂ and 21 to 2n₂.

The control device 4 according to the present embodiment operates the control units 11 to 1n₂ identifying the control models 31 to 3n₁ by learning and the control units 21 to 2n₂ having one or more existing control models 41 to 4n₂, which are illustrated in FIG. 1 in parallel to output the action value and the action of each of the control units 11 to 1n₂ and 21 to 2n₂ to the action value selection unit 61, outputs a control output value (action) selected by the action value selection unit 61 to at least one actuator 3 or the like mounted inside a machine, and updates the parameters of the control models 31 to 3n₁ of the learning destination control units 11 to 1n₁, based on observation data output from the sensor 2 and the selected action value.

The state acquisition unit 51 outputs state values matching a format to be input to each control model from one or more sensor values.

The action value selection unit 61 outputs the selected action to the actuator 3 and the selected action and action value to the learning unit 71. For example, an action having the maximum action value may be selected by using a Max function as action value selection means output from a plurality of the control units 11 to 1n₁ and 21 to 2n₂ by the action value selection unit 61, and stochastic selection means such as ε-greedy selection or Boltzmann selection may be taken.

The learning unit 71 temporarily stores the state value output from the state acquisition unit 51, the action value and the action output from the action value selection unit 61 in the data storage unit 81, and then reads data used for learning from the data storage unit 81.

The learning unit 71 is connected only to the control units 11 to 1n₁ that update the parameters of the control models, and updates the parameters of each of the control models 31 to 3n₁, based on the read data. Data of the past several times stored in the data storage unit 81 may be used as the read data.

For example, table data such as a Q table of Q learning for discretely designing the number of states may be used as the state values in learning, or a neural network that can handle continuous values may be used.

By structurally separating the control units 11 to 1n₁ and 21 to 2n₂ operating in parallel from the learning unit 71, only the control units 11 to 1n₁ having the control models 31 to 3n₁ to be updated can update parameters.

The control device 4 can be configured on, for example, a general-purpose computer, and a hardware configuration (not illustrated) of the control device 4 includes an arithmetic unit configured by a central processing unit (CPU), a random access memory (RAM), and the like, a storage unit configured by a read only memory (ROM), a hard disk drive (HDD), a solid state drive (SSD) using a flash memory or the like, and the like, a connection device of a parallel interface format or a serial interface format, and the like.

The state acquisition unit 51, the control units 11 to 1n₁ and 21 to 2n₂, the action value selection unit 61, the learning unit 71, and the selection monitoring unit 91 realize multitasking by loading a control program stored in the storage unit to the RAM and executing the control program by using the CPU. Alternatively, those may be configured by a multi-CPU configuration or may be configured by dedicated circuits, respectively.

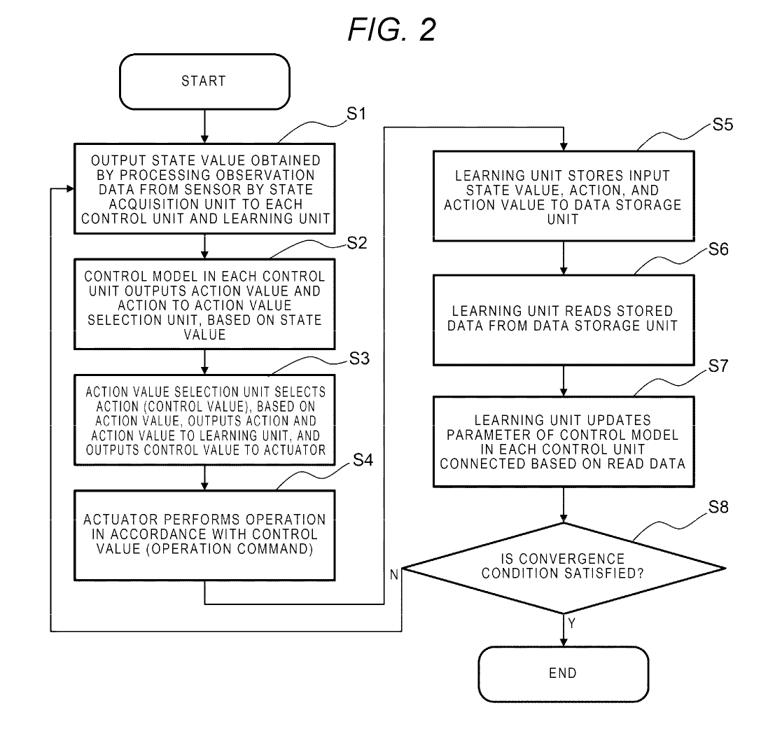

Next, a basic operation flow will be described with reference to FIG. 2. First, it is preferable to start by setting an initial output of the control models 31 to 3n₁ of a learning destination (updating the parameter) to zero.

In step S1, a state value obtained by processing observation data from the sensor 2 by using the state acquisition unit 51 is output to each of the control units 11 to 1n₁ and 21 to 2n₂ and the learning unit 71.

In step S2, the control models 31 to 3n₁ and 41 to 4n₂ in the respective control units 11 to 1n₁ and 21 to 2n₂ calculate an action value and an action based on the state value and output the calculated action value and action to the action value selection unit 61.

In step S3, the action value selection unit 61 selects an action (a control value which is output to the actuator), based on the action value output from each control model, outputs the selected action and action value to the learning unit 71, and outputs the control value (selected action) to the actuator 3.

In step S4, the actuator 3 performs an operation according to the control value (operation command).

In step S5, the learning unit 71 stores the action value and the action output from the action value selection unit 61, and the state value output from the state acquisition unit 51, in the data storage unit 81.

In step S6, the learning unit 71 reads necessary storage data from the data storage unit 81.

In step S7, the learning unit 71 updates the parameters of the control models 31 to 3n₁ of the control units 11 to 1n₁ connected based on the read data.

In step S8, if a certain convergence condition (for example, a degree of update of the parameters of the control models 31 to 3n₁ is within a predetermined tolerance) is satisfied, it is determined that learning of the control model for achieving the target task ends, and the learning ends. If the convergence condition is not satisfied, the processing proceeds to S1 and the learning is repeated.

The selection monitoring unit 91 monitors a situation of learning by displaying the action value and the action selected by the action value selection unit 61 and the number of times of each of the selected control units 11 to 1n₁ and 21 to 2n₂, on, for example, a visualization tool such as a display connected to the outside of the control device 4, or by taking a log and describing in text. For example, it can be used as information for changing a connection relationship with the learning units 71 of the control models 31 to 3n₁ of a learning destination and the existing control models 41 to 4n₂, based on the monitoring results.

### Embodiment 2

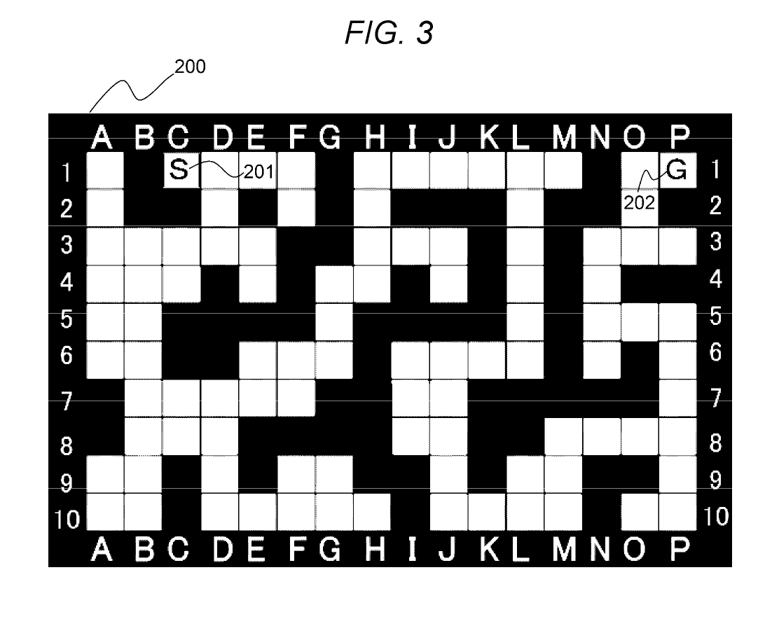

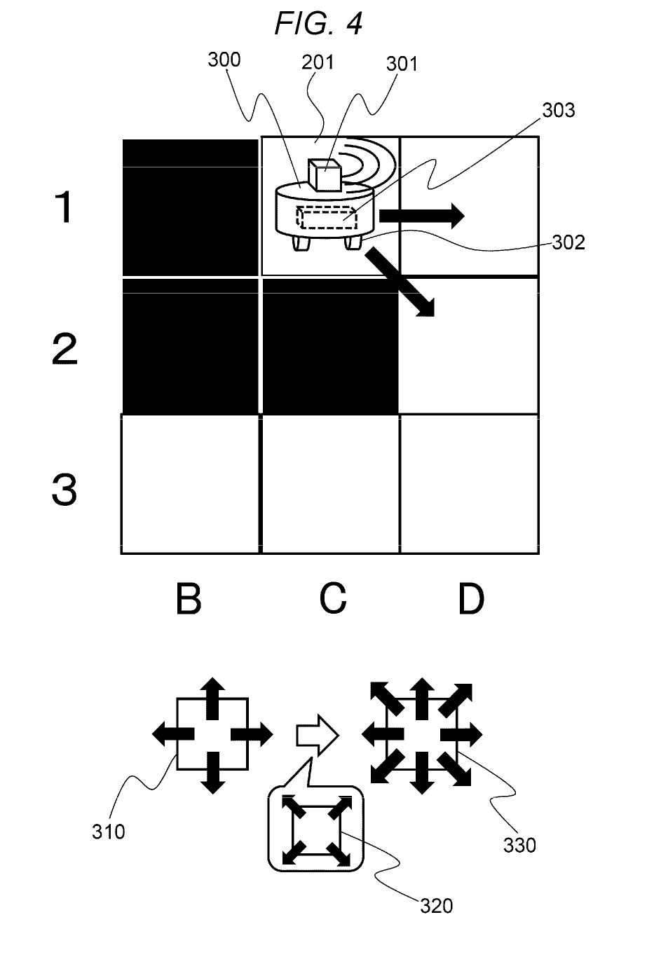

In the present embodiment, an efficient learning example in the optimum path search of a carriage travel robot 300 illustrated in FIG. 4 using a complex maze 200 as illustrated in FIG. 3 is illustrated as a specific example of Embodiment 1. Here, it is defined that a self-positioning measurement device 301 that plays a role of a sensor 2 is mounted in a robot, and the robot includes a motor drive wheel 302 that plays a role of the actuator 3 and a control device 303 for a carriage travel robot. Thus, in the present embodiment, learning will be described in which a coordinate value (state value) of the robot is input from the self-positioning measurement device 301, and the control device 303 for the carriage travel robot moves a control value acquires a control model that outputs a control value for moving by one grid square in eight directions of vertical, horizontal, and diagonal directions to the motor drive wheel, based on the coordinate value.

The control model updating method according to the present embodiment illustrates that learning time can be shortened and a shortest path can be obtained by learning additional control model 320 moving in diagonal four direction, based on the existing control model 310 learned by moving in four directions, compared with a case of learning the control model 330 in eight directions from a state where an initial value is set to zero.

In each grid square of the maze 200 illustrating FIG. 3, a white grid square is a path and a black grid square is a wall, and it is possible to advance only on a white grid square. In the present embodiment, the grid square 1-C in FIG. 3 is set as a start point 201, and the grid square of 1-P is set as a goal point 202.

In the present embodiment, an example using Q learning in reinforcement learning is illustrated as a learning method for acquiring a control model. The Q learning is a method of learning a value (action value) Q(s,a) for selecting an action a under a certain state value s obtained by processing the observation data from the sensor 2 by using the state acquisition unit 51. At the time of a certain state value s, the highest a of Q(s,a) is selected as an optimal action. However, at the beginning, a correct value of Q(s,a) for each combination of s and a is not known at all. Therefore, by trial and error, various actions a are taken under a certain s, and the correct Q(s, a) is learned by using reward at that time.

A Q table according to the present embodiment holds the grid square of each maze, and a coordinate value represented by symbols 1 to 10 and A to P in the vertical and horizontal directions is set as the state value s. In addition, scores are allocated for each grid square (predefined by a designer), and this is searched as a reward value r. The control model 330 in eight directions is handled one by one in the vertical, horizontal, and diagonal directions as the action a. For the Q learning, state transition calculation is performed by using the following updating formula.

$$Q ( {s}_{t} , {a}_{t} ) ← Q ( {s}_{t} , {a}_{t} ) + α [ {r}_{t + 1} + γ {max}_{{a}^{′}} Q ( {s}_{t + 1} , {a}^{′} ) - Q ( {s}_{t} , {a}_{t} ) ] \qquad ( 1 )$$

Here, α is a parameter that is called a learning rate and adjusts a degree of learning, and γ is a weight factor that is called a discount rate and is used for calculating reward in which passage of time is considered (If an action is made over time, reward which is obtained even by the same action is reduced more than a reward obtained by a fast action). In a case of the present embodiment, a condition is set such that a reward value 100 is obtained in a case of reaching a goal point 202. In addition, sₜ₊₁ represents a state value received at a next time of the time when action a is selected in sₜ. a′ indicates an action in which an action value of sₜ₊₁ is maximized in the state value sₜ₊₁. An updating formula of formula 1 indicated that if the best action value Q(sₜ₊₁,a′) in the next state value sₜ₊₁ by the action aₜ is greater than the action value Q(sₜ,aₜ) of the action aₜ in the state value sₜ, learning is made in which Q(sₜ,aₜ) increases, and in contrast to this, if it is small, learning is made in which Q(sₜ,aₜ) decreases. That is, learning is made in which a value of a certain action in a certain state approaches the best action value in the next state by thereby. There is a learning method in which the best action value in a certain state is propagated to an action value in the previous state.

In the present embodiment, the existing control model is specifically set as a Q table (Q_{A}) in which a convergence condition is obtained when continuously reaching the goal 10 times on the shortest path in a shortest path search problem movable in the vertical and horizontal four directions. In addition, the control model of a synthesis destination (the control model for updating parameters) is specifically set as a Q table Q_{Z} in which a convergence condition is obtained when continuously reaching the goal 10 times on the shortest path in a condition movable in eight directions to which the diagonal four directions are added. The existing control model Q_{A} is synthesized (learned) to the control model Q_{Z} of a synthesis target by the following method. For example, Q_{A} can be synthesized with Q_{Z} by establishing the following updating formula.

Q_{Z}(sₜ,aₜ)←Q_{Z}(sₜ,aₜ)+α[Q′_{Z}(sₜ₊₁,a′)−Q_{Z}(sₜ,aₜ)] (2)

Here, Q′_{Z}(sₜ₊₁,a′) is represented by Formula (3).

$${Q}_{Z}^{′} ( {s}_{t + 1} , {a}^{′} ) = {r}_{t + 1} + γ {max}_{{a}^{′}} ( {Q}_{Z} ( {s}_{t + 1} , {a}^{′} ) , {Q}_{A} ( {s}_{t + 1} , {a}^{′} ) ) \qquad ( 3 )$$

In general Q learning, the Q learning is updated by selecting the action with the highest action value in a certain state, but in Formula (2) and Formula (3), an action is selected by comparing the maximum action values of the synthesis destination control model Q_{Z} and the existing control model Q_{A}. At least one of the respective control models is required.

Furthermore, in order to reduce a probability that an existing model is selected even in a state where learning is sufficiently progressed, for example, an oblivion factor f may be defined as in Formula (4), and a factor f multiplied by the action value according to the progress of learning may be provided.

$${Q}_{Z}^{′} ( {s}_{t + 1} , {a}^{′} ) = {r}_{t + 1} + γ {max}_{{a}^{′}} ( {Q}_{Z} ( {s}_{t + 1} , {a}^{′} ) , {fQ}_{A} ( {s}_{t + 1} , {a}^{′} ) ) \qquad ( 4 )$$

As for the factor f, a constant value may be subtracted from the oblivion factor for each trial, and a method of gradually making a selection probability of the existing control model approach zero may be adopted.

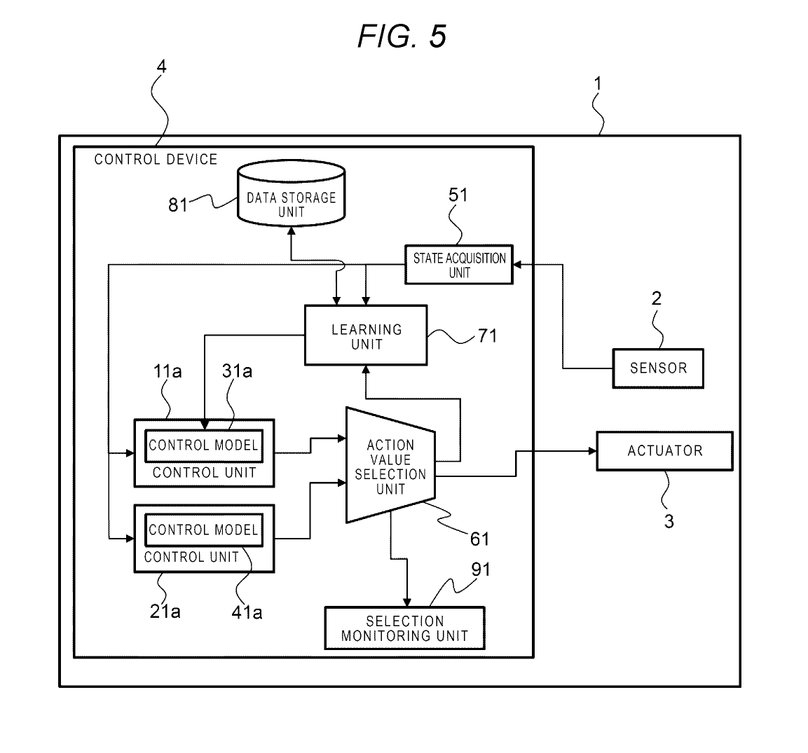

A configuration of the control device according to the present embodiment is as illustrated in FIG. 5. One control unit 11a that updates a parameter of the control model 31a and a control unit 21a having one existing control model 41a are operated in parallel.

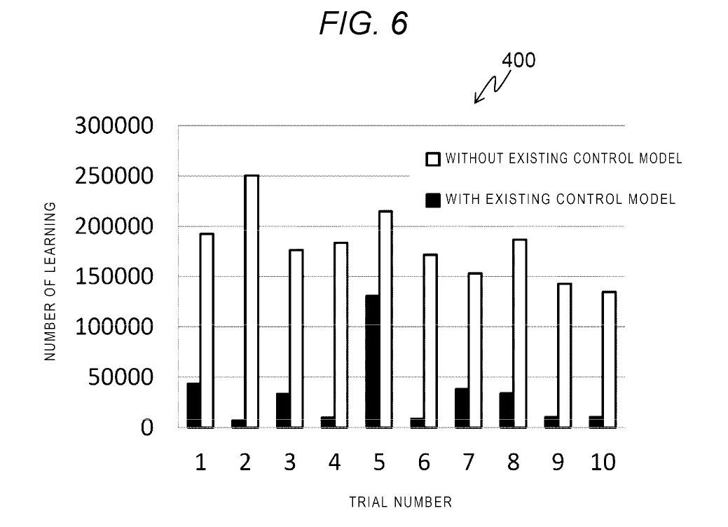

In order to verify that learning becomes more efficient by the above-described synthesis learning, an experiment was performed to compare the number of trials until reaching a convergence condition. First, in a case where the present invention is not applied, when the control model 330 of one to eight direction movement is learned, measuring the number of learnings is tried until the goal is reached ten times. Next, learning of the control model 310 in four directions is previously performed, and measuring the number of learnings until the control model 330 in eight directions is acquired based on the control model 310 in the four directions is tried until the goal is reached ten times. A comparison result 400 of the measurement is illustrated in FIG. 6.

As can be seen from the result 400 illustrated in FIG. 6, it can be confirmed that speedup of approximately 10 times is achieved on average. In addition, if t verification is performed based on the results of 10 trials in this verification, a P value becomes 3.35E−07, and a dominant difference can be confirmed. Effects of the present invention are represented from the above results.

In the present embodiment, general Q learning is used, but if a state space is wide and it is attempted to express a state by a method like a Q table, in a case where a huge table is required, for example, learning may be made by using a method of performing approximate expression of Q learning by a machine learning method of handling continuous values such as a neural network.

### Embodiment 3

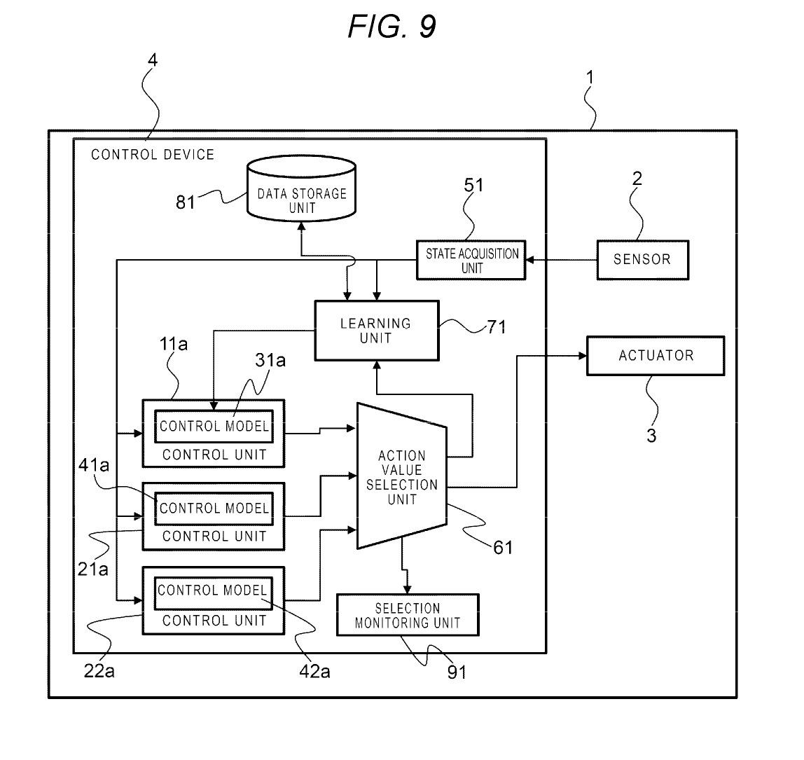

Next, Embodiment 3 of the present invention will be described. A control device 4 according to Embodiment 3 illustrated in FIG. 9 has two control units 21a and 22a including existing control models 41a and 42a with different inputs from the sensor 2. In addition, the control device includes one control unit 11a having the control model 31a of a synthesis destination with the above-described different both inputs as input information.

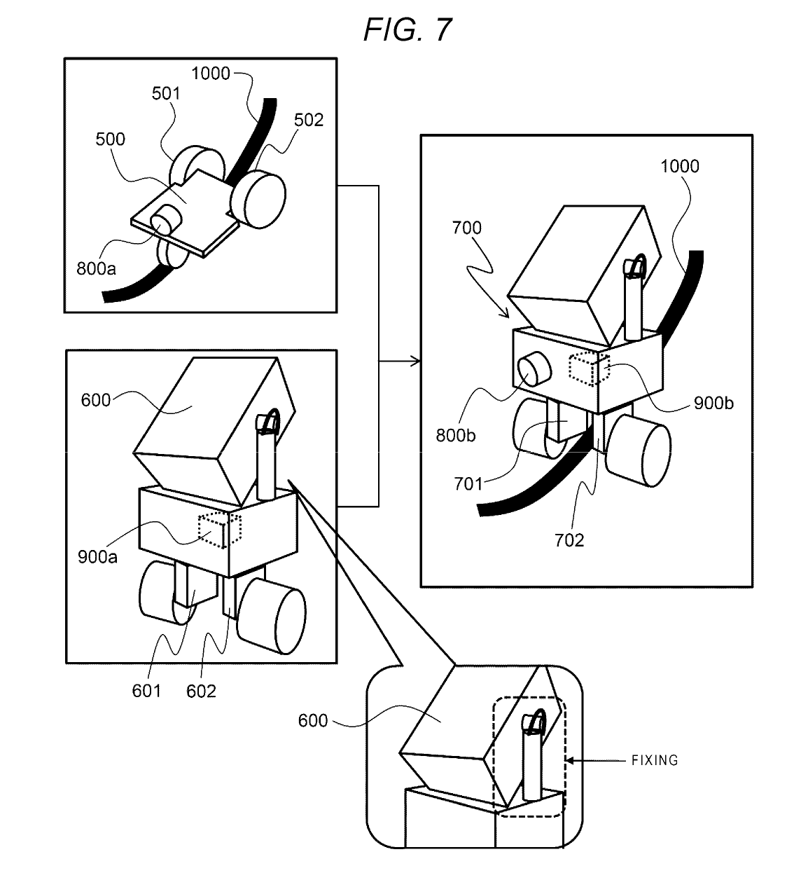

The present embodiment provides an example in which the control model 31a of an inversion pendulum line tracer robot 700 that traces a line while inverting is acquired an inversion movement control model 41a of an inversion pendulum robot 600 and a steering control model 42a of a line tracer robot 500 as an existing control model which are illustrated in FIG. 7. Here, in addition to a method of acquiring the control model 31a of synthesis destination which uses reinforcement learning, a method of acquiring the inversion movement control model 41a and the steering control model 42a which are existing control models.

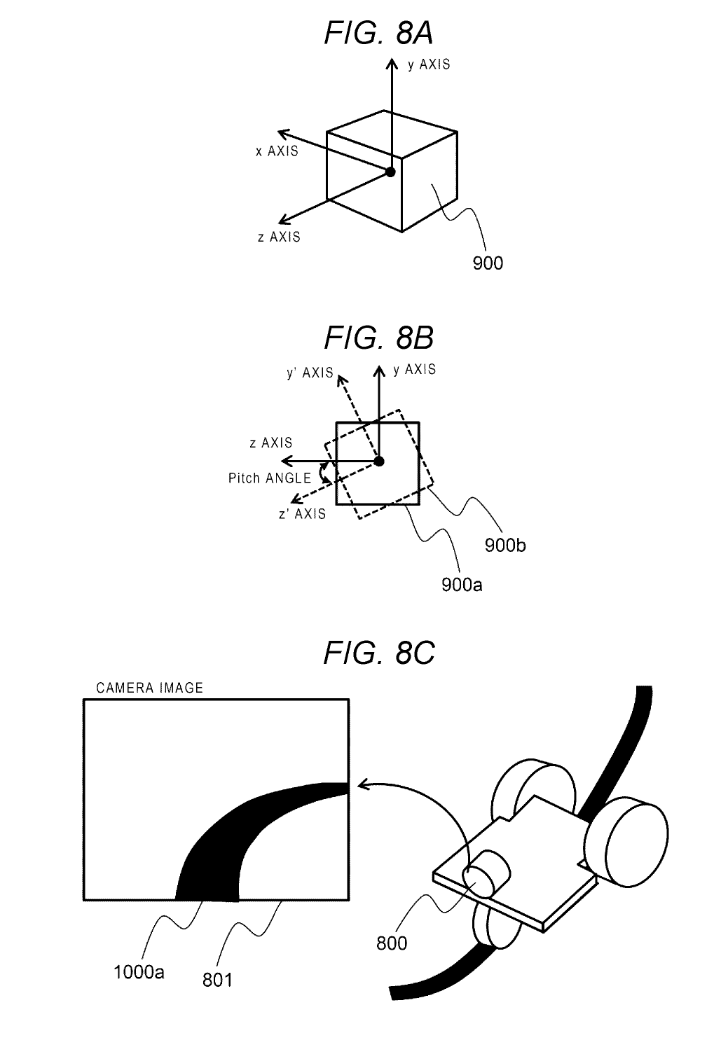

The inversion pendulum robot 600 has a rigid body shape in which a cuboid block is similarly assembled with a body on two wheels as illustrated in FIG. 7. Since a target task of moving while inverting is achieved under a control of the inversion pendulum robot 600, output values of motors 601 and 602 connected to wheels in the feet of the robot are determined, for example, based on a Pitch angle of an IMU sensor 900a (a device that detects an angle (or angular speed) and acceleration of three axes controlling a motion) built in the robot and an angular speed thereof (see FIGS. 8A and 8B), as the input information.

In order to acquire an inversion movement control model, for example, in a case where a stable inversion movement with less shaking can be made, a reward design in which a good reward is given may be performed. Specifically, in a case where a variation value of an angular speed is within a certain threshold value, a method of giving reward 1 may be adopted. In addition, if it becomes a certain angle, a reward design in which −1 is given as punishment may be performed, but is not limited to the method.

Meanwhile, the line tracer robot 500 has a structure including three wheels as illustrated in FIG. 7. Since a task of a purpose of traveling along a line 1000 is achieved under a control of the line tracer robot 500, for example, output values of the motors 501 and 502 connected to the wheels are determined such that a target steering angle is obtained as input information, based on a camera image 801 of a vision sensor (camera) 800a mounted in front of the carriage as illustrated in FIG. 8C, for example.

In order to acquire a steering control model, for example, in a case where a reward value is calculated based on the image 801 obtained from the camera 800a, a higher reward value close to 1 is given as the line 1000a appearing in a screen is at the center of the image, and in a case where the travel deviates along the line 1000a disappearing from the image 801, a gradual difference may be provided in the reward value by setting a reward design to which −1 is given, but is not limited to the method.

Since a task of a target moving along the line 1000 while inverting is achieved under a control of the inversion pendulum line tracer robot 700 of a synthesis destination, output values of the motors 701 and 702 are determined based on a Pitch angle of a built-in IMU sensor 900b and an angular speed thereof and an image 801 of the camera 800b, as input information.

The above-described learning uses a value of the IMU sensor 900b as the input information of the inversion movement control model 41a, the steering control model 42 a uses the image 801 of the camera 800b as the input information, and the control model of synthesis destination uses both the value of the IMU sensor 900b and the image 801 of the camera 800b as the input information, but it is possible to synthesize even in a case where the input information of the existing control model and the input information of the control model of synthesis destination do not necessarily match as such.

In a case where a high-dimensional target such as the camera image 801 is handled, it is difficult to prepare a Q table Q(sₜ,aₜ) covering all states and actions as in Embodiment 2, and even in a realistic implementation, the amount of memory is insufficient, and thereby, it can be said that it is impossible. Therefore, a method of approximating the Q table which is a value function may be adopted. Here, it is assumed that Q(sₜ,aₜ) is represented by using a certain parameter θ, and is represented by an approximated function Q(sₜ,aₜ; θ) as represented by Formula (5).

Q(sₜ,aₜ;θ)≈Q(sₜ,aₜ) (5)

As a method of related art, an algorithm based on a gradient method is often used, the following loss function is defined, and a differentiation value thereof is used for updating parameters. Here, the sum of squares is defined as a loss function as represented by Formula (6) as a frequently used method, but, for example, an absolute value difference, a Gaussian function, and the like may be used, and the present invention is not limited to the method.

$$L ( θ ) = \frac{1}{2} {( target - Q ( {s}_{t} , {a}_{t} ; θ ) )}^{2} \qquad ( 6 )$$

Here, target is called a teacher signal in machine learning and is a value of correct answer to a problem. A differentiation value of the loss function is used for updating the parameter θ of the approximated Q function (Formula (7)).

$$θ ← θ - η \frac{\partial L ( θ )}{\partial θ} \qquad ( 7 )$$

In the framework of reinforcement learning described as in the present embodiment, a true action value Q*(s, a) is not known, and thus, a value of target cannot be given explicitly. Therefore, in the same manner as the Q learning which uses the Q table according to Embodiment 2, the target is defined like Formula (8), thereby, being used as the teacher signal.

$$target = r + γ {max}_{{a}^{′ }} Q ( {s}_{t + 1} , {a}^{′} ; θ ) \qquad ( 8 )$$

Here, r and γ are the same as those defined in Embodiment 2. a′ indicates an action whose Q value becomes maximum in the state value sₜ₊₁. Here, it is necessary to be careful that maxQ is not differentiated because of being handled as a teacher signal. Thus, differentiation of the loss function is represented by Formula (9).

$$\frac{\partial L ( θ )}{\partial θ} = - ( r + γ {max}_{{a}^{′}} Q ( {s}_{t + 1} , {a}^{′} ; θ ) - Q ( {s}_{t} , {a}_{t} ; θ ) ) \frac{\partial Q ( {s}_{t} , {a}_{t} ; θ )}{\partial θ} \qquad ( 9 )$$

There is a method of approximating a function using, for example, a neural network or the like as a machine learning method having a high expression capability in the above function approximation. In the neural network, θ denotes parameters such as a weight and a bias in coupling between units.

The neural network is configured by using a plurality of neurons that output an output y for a plurality of inputs x. Each input x and a weight w are vectors. If the input x is input to one neuron, an output value is represented by Formula (10).

$${f}_{k} ( x ) = {\sum }_{i = 1}^{n} {w}_{i} {x}_{i} + b \qquad ( 10 )$$

Here, b is a bias and fₖ is an activation function. A plurality of neurons are combined to form a layer.

Learning updates the weight w and determines a connection between neurons. A neural network is provided for each of the control units 11a, 21a, and 22a, and only parameters of the neural network of a synthesis destination are updated.

The control model 41a of the inversion pendulum robot 600 forms, for example, a neural network of four layers to which the Pitch angle of the IMU sensor 900b and angular speed information thereof are input, and the line tracer robot 500 may have a structure in which, for example, a neural network of five layers to which a 640×480 camera image 801 is input. In this case, an input to the neural network of the inversion pendulum line tracer robot 700 is the image 801 of the camera 800b having the same size as the neural network of the line tracer robot 500 the pitch angle of the IMU sensor 900b, and an angular speed thereof.

If learning is made by combining a camera image which is multidimensional data and information of two-dimensional IMU sensor data from the beginning as one piece of input information, an opening appears in the data dimension number of both. Accordingly, influence of the data of the IMU sensor 900b on the camera image data decreases and learning of the inversion movement control model is not made well. Thus, learning can be made by having, for example, the following structure as a structure of the neural network.

In the neural network of the inversion movement control model 41a to which the IMU sensor data is input and the neural network of the steering control model 42a to which the camera image is input, a structure up to the layer one or two before the output layer has the same network structure as the neural network of the existing control model, and by combining two vectors into one vector in the next layer, it is possible to handle without affecting the input information having the smaller number of dimensions even for inputs with a greatly different dimension.

The action value selection unit 61 determines an action to be taken, based on the action value which is information of three output layers of the inversion movement control model 41a of the inversion pendulum robot 600, the steering control model 42a a of the line tracer robot 500, and the control model 31a of the inversion pendulum line tracer robot 700. In the same manner as in Embodiment 2, an action value selection method of the action value selection unit 61 may select an action with the maximum action value using a Max function, or may take probabilistic selection means such as ε-greedy selection or Boltzmann selection, but the present invention is not limited to the selection method.

FIG. 9 illustrates an example of synthesizing the control models of the line tracer robot 500 and the inversion pendulum robot 600 with the control model of the inversion pendulum line tracer robot 700. The inversion pendulum line tracer robot 700 performs a task that moves with respect to the inversion pendulum robot 600, while moving along the line 1000, and a search range of learning also increases. Accordingly, it is more difficult for the inversion pendulum line tracer robot 700 to identify the control model 31a than the inversion pendulum robot 600, and the time required for the search increases, or there arises a problem that the search cannot be completed without reaching the optimum solution.

In order to solve the above problem, the inversion movement control model 41a acquired by the inversion pendulum robot 600 and the steering control model 42a acquired by the line tracer robot 500 are stored, the control model 31a of the inversion pendulum line tracer robot 700 of a synthesis destination and the two existing control models are connected in parallel, and the control model 31a of the synthesis destination is synthesized by performing the learning of updating only the control model parameter of the synthesis destination. Here, if an action value output by each control unit is referred to as a Q value, updating parameters of each Q value is learned.

In an initial step (0≤t<t1) of learning, an inversion movement control model is first acquired, standing at a target speed is required, and thus, the inversion movement control model 41a of the inversion pendulum robot 600 is selected as an operation with a high action value. In addition, it is possible to receive reward value according to a stable inversion. The results are fed back to the control model 31a of a synthesis destination to make learning, and thereby, an inversion movement control model is acquired.

Next, in a second half step (t1≤t<t2), an action value of a steering control model of a line tracer increases when inverting along the line 1000. Here, it is possible to receive a higher reward value as the line 1000 is at the center of the camera image 801. The parameters of the control model 31a of a synthesis destination are updated based on the feedback.

Finally, since the highest action value and reward are received as the movement along the line 1000 is made, an action value with the highest Q value of a synthesis destination is calculated, learning is stabilized, and thus, synthesis is completed.

In the same manner as in Embodiment 1 and Embodiment 2, the selection monitoring unit 91 can confirm progress of the learning or which action value is selected. For example, the inversion pendulum line tracer robot 700 cannot move along a line unless being inverted. Accordingly, in a case where only an output value of the steering control model 42a is selected at a step where an inversion is not made as a method of utilizing the selection monitoring unit 91, it is also possible to make setting in which an output value of the inversion movement control model 41a is selected temporarily and preferentially.

### Embodiment 4

Next, Embodiment 4 of the present invention will be described. Embodiment 4 illustrates an example in which two control units, each including a control model for updating parameters, are connected.

In this embodiment, an example of decomposition opposite to the synthesis described in Embodiment 2 and Embodiment 3 will be described. Specifically, an example will be described in which the control model 41a of the inversion pendulum line tracer robot 700 is decomposed into the steering control model 31a of the line tracer robot 500 and the inversion movement control model 32a of the inversion pendulum robot 600.

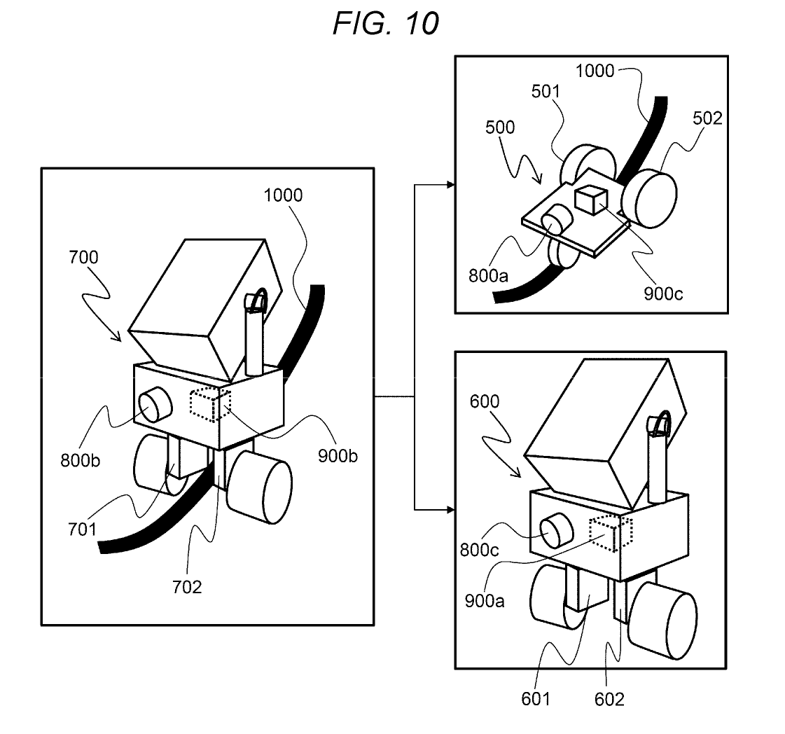

A method of acquiring a control model is the same as the synthesis learning of Embodiment 3, but is different from Embodiment 3 in that the control model 41a of a decomposition source is one, whereas the control models 31a and 32a of a decomposition destination which update parameters are two or more. A robot includes an inversion pendulum robot 600, a line tracer robot 500, and an inversion pendulum line tracer robot 700 in the same manner as the synthesis learning according to Embodiment 3, as illustrated in FIG. 10.

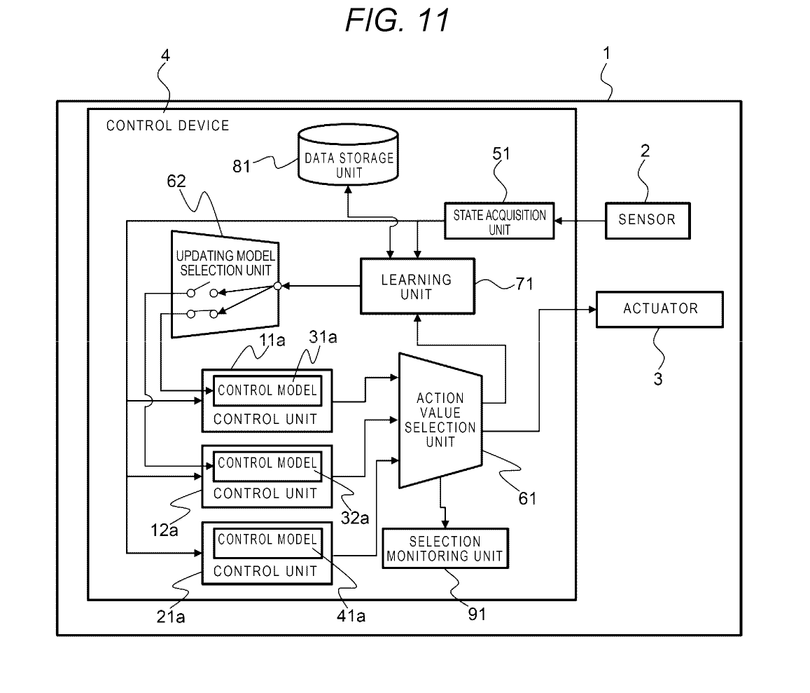

In a case where there are a plurality of control models in which parameters are updated, an updating model selection unit 62 illustrated in FIG. 11 is provided, a function capable of sequentially switching a connection with the learning unit 71 is included, and thereby, it is possible to stop parameter updating of a control model for which learning is completed even if parameters of other control models are being updated. As can be seen from a configuration diagram, in a case where the learning unit 71 and the control models 31a and 32a that update the parameters are all connected in the updating model selection unit 62, those are not different from the configuration diagrams so far.

By sequentially switching the connection with the updating model selection unit 62 in accordance with an action of the inversion pendulum line tracer robot 700, it is possible to make efficient learning of the steering control model 31a for the line tracer robot 500 and the inversion movement control model 32a of the inversion pendulum robot 600. By performing the above processing, in the learning of decomposition, it is possible to acquire a control model of an element from a complex control model in decomposition learning.

In the same manner as at the time of the synthesis learning, the above three control models make learning in a state of being connected in parallel. The learning unit 71 is connected to the control units 11a and 12a having a control model of the decomposition destination. The control units 11a and 12a respectively including the steering control model 31a of a decomposition destination and the inversion movement control model 32a are connected to the learning unit 71 as illustrated in FIG. 11.

Output values of the control models 31a and 32a are output to the action value selection unit 61 together with an output value of the control model 41a of a decomposition source. The steering control model 31a and the inversion movement control model 32a, which are control models of each, output the amount of operation of motors 501, 502, 601, and 602 connected to appropriate wheels of each robot in accordance with an input from the camera 800 or the IMU sensor 900, and acquire a control model which achieves a target task.

In learning of decomposition, a reward function matching a target control may be set for each control model of a decomposition destination, and a method of providing the updating model selection unit 62 illustrated in FIG. 11 and providing a mechanism for switching a control model to be learned in a switch manner may be adopted as an effective method in a case where there are a plurality of control models to be learned.

In learning of the line tracer robot 500, a steering angle is obtained from a relationship between an image of the line 1000 appearing in the camera image 801 and a speed, and output values of the motors 501 and 502 matching the steering angle are determined. The inversion movement control model 32a is not required, but is connected to the learning unit 71 as a control model for updating parameters. In the learning, a neural network which is the same as the control model of the inversion pendulum line tracer robot 700 is used as the existing control model, and thus, a method of matching input information from a sensor may be adopted. Specifically, like the line tracer robot 500 of FIG. 10, the existing control model 41a is used for an input and an output as it is by attaching the camera 800a and the IMU sensor 900c and matching an input condition to the inversion pendulum line tracer robot 700. Thus, by making the same learning as the synthetic learning according to Embodiment 3, the steering control model 31a of the line tracer robot 500 is acquired. The learning may be made by externally matching input information necessary for the existing control model and by using the control device based on the configuration diagram of FIG. 11. In a case where it is difficult to mount the IMU sensor 900c, learning may start by setting an input value of the IMU sensor 900c to zero.

Learning of the inversion pendulum robot 600 is also a learning method which is the same as the learning of the line tracer robot 500. The inversion pendulum robot 600 may take a form in which variation of an inversion posture is learned by using only IMU sensor information. Thus, in the same manner as the learning of the line tracer robot 500, by mounting the camera 800c and the IMU sensor 900a and matching the input information of a sensor, the existing control model can be used for an input and an output as it is. In contrast to the line tracer robot 500, the steering control model 31a for traveling along the line is not required, but is connected to the learning unit 71 as a control model for updating parameters. The inversion movement control model 32a is acquired by a control device based on the configuration diagram of FIG. 11. In a case where it is difficult to mount the camera 800c, learning may start by setting an input value of the camera 800c to zero.

### Embodiment 5

Next, Embodiment 5 of the present invention will be described. Embodiment 5 illustrates an example in which two control units including a control model for updating parameters are connected in consideration of replacement of input information by reward and transition of an action value.

In the learning of the steering control model 31a of the line tracer robot 500 according to Embodiment 3 and Embodiment 4, as long as work such as unevenness is applied to the line 1000 itself drawn by environment and thereby vibration or the like does not occur, line 1000 cannot be recognized only by information of the IMU sensor 900c. Accordingly, under the condition that only the IMU sensor 900c and the camera 800a can be selected as the sensor, selection of the camera 800a is indispensable. Meanwhile, the inversion pendulum robot 600 can acquire a control model by using the IMU sensor 900a, the camera 800c, or both. Thus, in a case where the type of a sensor to be handled is intended to be limited, it is preferable to acquire a target control model using the same sensor.

In Embodiment 3 and Embodiment 4 described above, acquisition of an inversion movement control model is based on data of the IMU sensor 900a, but a method of obtaining the inversion movement control model in a case where the camera 800c is used will be described. Hereinafter, an example will be considered in which the inversion movement control model 31b having the IMU sensor 900a of the inversion pendulum robot 600 as an input and the inversion movement control model 32b having the camera 800c as an input are learned.

In a case where learning of the inversion movement control model 31b is made by using the Pitch angle of the IMU sensor 900a and the angular speed thereof, and in a case where learning of the inversion movement control model 32b is made by using the camera 800c, the number of dimensions greatly differs, and thus, time required for learning greatly differs. In learning which uses data of the IMU sensor 900a, the learning is made from two-dimensional information, whereas, for example, in a case where 640×480 pixels are used as an image size of the camera 800c, the learning is made based on information of 307200 dimensions. Thus, since learning made by the data of the IMU sensor 900a drastically shortens learning time, a case where data of the IMU sensor 900a is used and a case where the camera 800c is used are simultaneously learned, and a method of switching to learning using the camera image 801 in the situation where learning is made is taken.

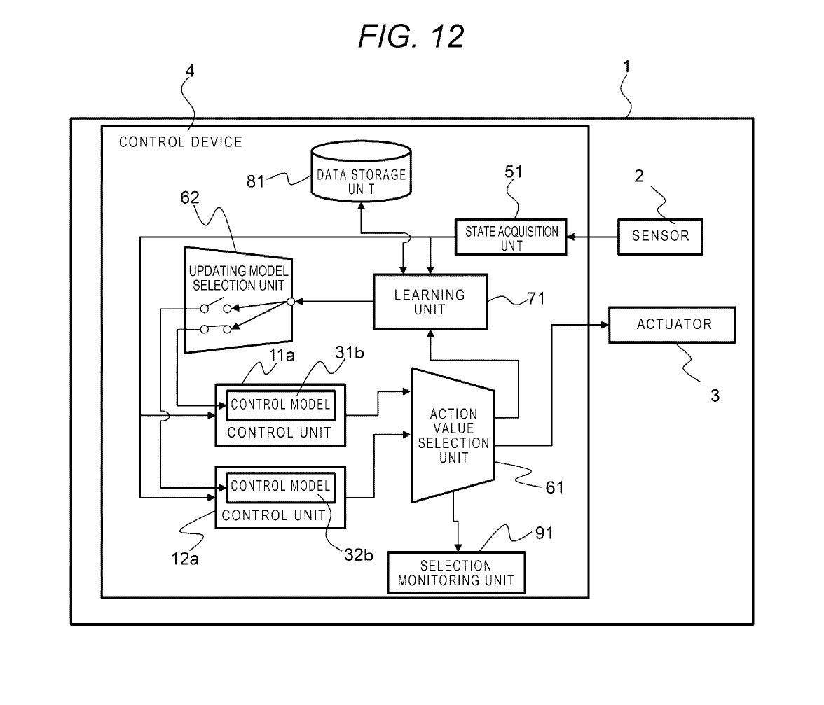

For the inversion pendulum robot 600 of FIG. 10, learning may be made by using a control device based on a configuration diagram of FIG. 12. Specifically, a control model used this time makes learning by using methods described in Embodiment 3 and Embodiment 4 by operating in parallel the control units 11a and 12a having the control models 31b and 32b that update parameters. Learning of the control model 31b receiving data of the IMU sensor 900a having the much smaller number of dimensions is completed first, and the inversion pendulum robot 600 starts to invert. If learning of the control model 31b receiving the data of the IMU sensor 900a is completed, the updating model selection unit 62 is disconnected from the control model 31b, and only the control model 32b is connected. Until this step, selection of an output value of the control model 31b having the IMU sensor 900a as an input occupies most of the action value selection unit 61. An action value output from the control model 31b and reward obtained by actually acting are used for updating parameters of the control model 32b receiving the camera image 801. Thereby, a value of r+γ max Q (s′, a′; θ), which serves as teacher data of Formula (6) and Formula (8), is more successful data than the learning which uses only a control model receiving the camera image 801, and thus, it is possible to make efficient learning.

1. A control device comprising:
a state acquisition unit that acquires a state value of a control target from a sensor value;
a first control unit that includes a first control model and outputs an action of the control target and an action value, based on the state value and the first control model;
a second control unit that is connected in parallel to the first control unit, includes a second control model, and outputs an action of the control target and an action value, based on the state value and the second control model;
an action value selection unit that selects action values which are output from the first control unit and the second control unit; and
a learning unit that receives an action value and an action which are selected by the action value selection unit, stores the action value and the action together with the state value, and updates a parameter of the first control model which is included in the first control unit, based on the stored data.

2. The control device according to claim 1, wherein a plurality of the second control units having respectively different control models which are included therein are provided in parallel.

3. The control device according to claim 1, wherein a plurality of the first control units having respectively different control models which are included therein are provided in parallel.

4. The control device according to claim 1, wherein a plurality of the first control units having different control models which are included therein, and a plurality of the second control units having different control models which are included therein are commonly provided in parallel.

5. The control device according to claim 3, further comprising
an updating model selection unit that is connected to the plurality of first control units and selects to update parameters of a control model which is included in the first control unit.

6. The control device according to claim 1, further comprising:
a selection monitoring unit that monitors a control model which is selected by the action value selection unit.

7. A control method comprising:
a step of acquiring a state value of a control target from a sensor value;
a step of causing a first control unit to output an action of the control target and an action value, based on the state value and the first control model which is included therein;
a step of causing a second control unit to operate in parallel with the first control unit, and to output an action of the control target and an action value, based on the state value and a second control model which is included therein;
a step of causing an action value selection unit to select action values which are output from the first control unit and the second control unit, to output the selected action value and action to the learning unit, to output the selected action to an actuator of the control target, and to control an operation of the control target; and
a step of causing a learning unit to receive an action value and an action which are selected by the action value selection unit, stores the action value and the action together with the state value, and updates a parameter of the first control model which is included in the first control unit, based on the stored data.

8. The control method according to claim 7,
wherein the first control unit including the first control model therein is a plurality of control units, respectively including a different control model therein, and the plurality of control units operate in parallel with the second control unit, and
wherein the control method further includes a step of causing an updating model selection unit to select to update parameters of control models which are included in the plurality of control units.

9. The control method according to claim 7, further comprising:
a step of causing a selection monitoring unit to monitor a control model which is selected by the action value selection unit.

10. The control method according to claim 7, further comprising:
a step of providing an oblivion factor for each control unit in the action value selection unit, and
a step of causing the action value selection unit to multiply the oblivion factor which is provided for each action value that is output by the first control unit and the second control unit.

11. The control method according to claim 7, further comprising:
a step of providing an oblivion factor for each of the second control units in the action value selection unit, and
a step of causing the action value selection unit to multiply the oblivion factor which is provided for each action value that is output by the second control unit and to subtract a constant value from the oblivion factor for each trial.

12. The control device according to claim 4, further comprising
an updating model selection unit that is connected to the plurality of first control units and selects to update parameters of a control model which is included in the first control unit.

13. The control device according to claim 2, further comprising:
a selection monitoring unit that monitors a control model which is selected by the action value selection unit.

14. The control device according to claim 3, further comprising:
a selection monitoring unit that monitors a control model which is selected by the action value selection unit.

15. The control device according to claim 4, further comprising:
a selection monitoring unit that monitors a control model which is selected by the action value selection unit.

16. The control method according to claim 8, further comprising:
a step of causing a selection monitoring unit to monitor a control model which is selected by the action value selection unit.
